(19) United States
(12) Patent Application Publication
(10) Pub. No.: US 2011/0082960 A1
(43) Pub. Date: Apr. 7, 2011

(54) METHOD OF SERIAL BUS COMMUNICATION AND BUS INTERFACE DEVICE FOR THE SAME

(75) Inventors: Hyung Sun LEE, Daejeon (KR); John SUNWOO, Gwangju (KR)

(73) Assignee: Electronics and Telecommunications Research Institute, Daejeon (KR)

(21) Appl. No.: 12/878,143

(22) Filed: Sep. 9, 2010

(30) Foreign Application Priority Data
Oct. 6, 2009 (KR) 10-2009-0094548

(51) Int. Cl. G06F 13/14

(52) U.S. Cl. 710/305

(57) ABSTRACT

There are provided a serial bus communication method and a bus interface device showing excellent performance when a medium with low conductivity is used. The serial bus communication method includes: retrieving available transmission rate to a destination node to which data will be transmitted from a transmission rate table whenever transmitting data through a bus; setting data rate for transmitting the data to the destination node by using the retrieved available transmission rate when the available transmission rate to the destination node is retrieved in the transmission rate table; and transmitting the data at the data rate. Accordingly, transmission performance is improved on a network using a medium with low conductivity.

### CROSS REFERENCE TO RELATED APPLICATIONS

This application claims priority to Korean Patent Application No. 10-2009-0094548 filed on Oct. 6, 2009, the entire contents of which are herein incorporated by reference.

### BACKGROUND OF THE INVENTION

1. Field of the Invention

The present invention relates to serial bus communication and a bus interface, and more particularly, to a bus interface technology for controlling data rate of data transmitted to corresponding modules whenever transmitting the data in accordance with signal characteristics between modules that communicate with each other through a bus.

2. Description of the Related Art

With the advent of the ubiquitous era, a demand for computing equipment which a user can constantly use while carrying out in his/her body has increased. Therefore, an apparatus in a hand such as a PDA is generalized and furthermore, electronic textile (e-textile) apparatuses integrating a computing function in clothing closest to people's lives appear. Jackets with an MP3 function or exercise assisting or health function monitoring clothes, etc. has already been introduced to a market.

An electronic textile has a structure in which a hardware module having a computing ability is inserted into a conductive fabric fabricated by mixing a general textile and a conductive textile with each other. In recent years, a technology relating to a sensor for acquiring a user's vital sign or external environment information in the vicinity of a wearer by using the conductive fabric, etc. or an interfacing technology using the conductive fabric between the computing equipment and a user, etc. has been introduced.

The hardware modules provided in the electronic textile are distributed for a structural, functional, or aesthetic reason. For example, a sensor module for measuring a body temperature of the wearer is preferably positioned at an armpit part for a more accurate operation and an LED module for indicating an operation state is preferably positioned at a location (writs, etc.) which comes into a wear's view. A communication method for exchanging data and control information among the distributed modules is largely divided into a wireless communication method such as a body area network (BAN), a wireless personal area network (WPAN), etc. and a wired communication method such as a universal serial bus (USB), IEEE1394, a controller area network (CAN), RS-232, RS-485, Ethernet, etc.

Among the wireless communication methods, a sensor networking protocol has a characteristic of low power consumption, but cannot satisfy all various network requirements of the electronic textile and since a WPAN protocol such as Bluetooth has large power consumption, the WPAN protocol is difficult to apply to an apparatus that operates based on a battery, such as the electronic textile.

The above-mentioned wired communication methods have a premise to use an electric wire made of a metallic material having high conductivity and are difficult to apply to the electronic textile due to a lot of constraint conditions in a connection line.

In order for conductive yarn/thread used as the electronic textile to have an electrical conducting characteristic in addition to a physical characteristic to elongate when being pulled like thread, the conductive yarn/thread is fabricated by gathering filaments fabricated by coating general thread such as cotton, nylon, and polyester with metal such as gold (Au), silver (Ag), copper (Cu), nickel (Ni), or the like or a plurality of filaments formed by making thin metal to have a diameter of 10 μm or less. Therefore, in general, the conductive yarn/thread shows a lot of physical differences from a metal wire.

First, the conductive yarn/thread has conductivity lower than the metal wire and for example, the conductive yarn/thread has the conductivity at a minimum of 1/10 times to the maximum of 1/10000 times lower than the metal wire.

Second, when continuously exposed to physical stimulation such as friction, the metal wire has conductivity of 0 while being cut over a threshold point, but the conductive yarn/thread fabricated by gathering the plurality of filaments has conductivity that gradually decreases as the number of cut filaments increases.

In general, the conductivity of a communication bus influences the maximum bandwidth. Stray capacitance exists in an input/output stage of each module connected to the bus and high resistance of a medium causes a delay of a transmission signal and since a delay time of the signal is in inverse proportion to the maximum communication speed, the lower the conductivity is, the smaller the bandwidth is. Further, since characteristic impedance of a conducting wire is changed when the conductivity of a communication medium is changed, the degree of mismatch with a terminal resistor of the bus increase and noise of a signal line increases.

U.S. Pat. No. 6,778,930 discloses a technology for adjusting characteristics of a signal transmitted to the bus by measuring a distortion degree of the signal generated in the bus and U.S. Pat. No. 7,103,688 discloses a technology that divides the communication frame into two in order to efficiently use a bandwidth in data bus communication and transmits the first part at a predetermined speed and transmits the second part at a speed faster than the first part by controlling transmission speed in accordance with a signal quality, and U.S. Pat. No. 7,383,372 discloses a technology that divides a protocol into a request and actual transmission and transmits the request at a predetermined speed and transmits data at a speed of a mode selected from predetermined modes.

However, the prior arts just determine the communication speed of the entire bus on the basis of the condition of the entire bus and the prior arts are difficult to effectively apply to a bus having a large difference in transmission characteristics between nodes using the bus, such as the electronic textile.

Accordingly, a new serial bus communication method which can be efficiently applied to a bus using a medium with low conductivity, such as the electronic textile, etc. and a bus interface for the same are being acutely required.

### SUMMARY OF THE INVENTION

In order to solve the above-mentioned problems, an object of the present invention is to provide a serial bus communication method which can be efficiently applied to a bus using a medium with low conductivity, such as an electronic textile and a bus interface for the same.

Further, another object of the present invention is to improve communication band efficiency of the bus by using transmission speed optimized for each node with respect to the nodes connected to the bus.

In addition, yet another object of the present invention is to provide a serial bus communication method and a bus interface which can rapidly adapt to a change of physical and electrical characteristics of the bus.

According to an aspect of the present invention, there is provided a serial bus communication method that includes: retrieving available transmission rate to a destination node to which data will be transmitted from a transmission rate table whenever transmitting data through a bus; setting data rate for transmitting the data to the destination node by using the retrieved available transmission rate when the available transmission rate to the destination node is retrieved from the transmission rate table; and transmitting the data at the data rate.

The transmission rate table is updated based on characteristics of the signal measured together with the received data for each of nodes transmitting the received data through the bus.

The method further includes setting the data rate by using predetermined desired transmission rate at an initial stage when the available transmission rate for the destination node is not retrieved from the transmission rate table.

The setting the data rate sets the data rate to the desired transmission rate when the available transmission rate is higher than the predetermined desired transmission rate at an initialization stage.

According to another aspect of the present invention, there is provided a serial bus communication method that includes: setting available transmission rate relating to a node transmitting received data by considering characteristics of a signal measured together with data received through a bus; and updating a transmission rate table such that the set available transmission rate is available transmission rate for the node.

The transmission rate table is searched whenever data is transmitted through the bus and is used to set data rate used for the data transmission.

According to yet another aspect of the present invention, there is provided a bus interface device that includes: a bus transmitter transmitting data to a destination node at predetermined data rate set by searching a transmission rate table whenever transmitting the data; and a bus receiver receiving data through a bus and provides characteristics of a signal measured together with the received data to update the transmission rate table to a node transmitting the received data.

Available transmission rate is updated for each node transmitting the data received through the bus in the transmission rate table and the data rate is set by using the available transmission rate corresponding to the destination node.

The following effects can be obtained by the present invention.

According to the present invention, since communication speed optimized with respect to nodes connected to a bus having a large difference in transmission characteristics between nodes using a bus, such as an electronic textile, etc. is used, it is possible to improve communication band efficiency of the bus.

Further, since data transmission speed is set based on characteristics of a signal every data transmission, when the physical and electrical characteristics of the bus are changed, the present invention can rapidly adapt to the change, thereby improving communication performance of serial bus communication using the electronic textile, etc.

### BRIEF DESCRIPTION OF THE DRAWINGS

FIG. 1 is a block diagram showing one example of a bus topology;

FIG. 2 is a circuit diagram modeling bus topology when a medium having low conductivity is used as a wire;

FIG. 3 is a circuit diagram modeling a conductive thread constituted by several threads of filaments;

FIG. 4 is a block diagram showing a bus interface according to an embodiment of the present invention;

FIG. 5 is a block diagram showing an example of a bus transmitter shown in FIG. 4.

FIG. 6 is a block diagram showing an example of a bus receiver shown in FIG. 4;

FIG. 7 is a diagram showing one example a physical layer frame used in a bus interface of the present invention;

FIGS. 8 to 10 are diagrams showing one example of the SOF shown in FIG. 7;

FIG. 11 is a diagram showing one example of an analog filter and a signal analyzer of a bus receiver shown in FIG. 6;

FIG. 12 is an operational flowchart showing a serial bus communication method according to an embodiment of the present invention in data reception; and

FIG. 13 is an operational flowchart showing a serial bus communication method in data transmission according to an embodiment of the present invention.

### DETAILED DESCRIPTION OF THE PREFERRED EMBODIMENTS

Hereinafter, the present invention will be described in detail with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

Hereinafter, preferred embodiments of the present invention will be described in detail with reference to the accompanying drawings.

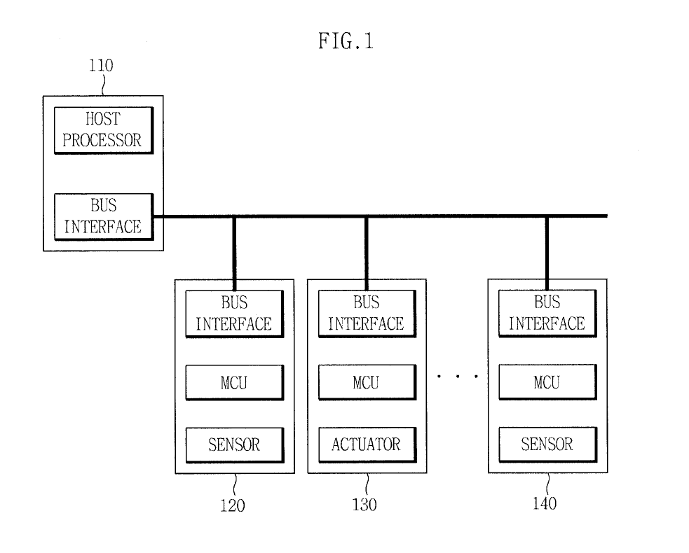

FIG. 1 is a block diagram showing one example of a bus topology.

Referring to FIG. 1, a host processor module 110 and hardware modules 120, 130, and 140 having a sensor/actuator, and a micro controller unit (MCU) are connected to each other through a common bus to exchange data.

In this case, each of the modules 110, 120, 130, and 140 corresponds to a node connected through the bus.

A copper wire having high conductivity has small wire resistance and thus a resistance component of the wire itself is ignored and the copper wire is generally modeled as a transmission line constituted by an inductor and a capacitance component.

However, when a medium having low conductivity, such as an electronic textile is used, the resistance component of the wire is too large to be ignored. Therefore, the medium should be modeled based on the resistance component.

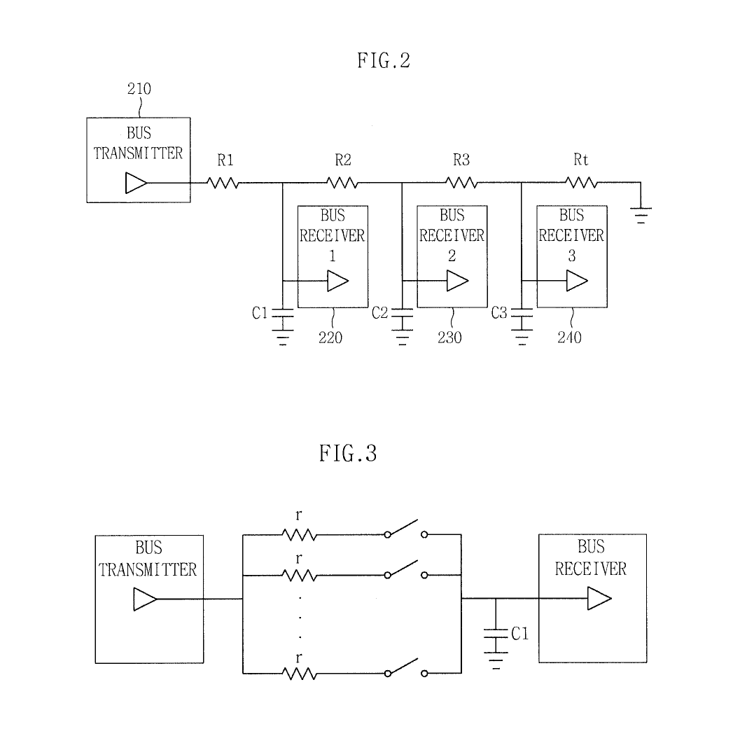

FIG. 2 is a circuit diagram modeling bus topology when a medium having low conductivity is used as a wire.

Referring to FIG. 2, resistance components between a bus transmitter 210 and bus receivers 220, 230, and 240 are modeled.

In FIG. 2, Rt represents a terminal resistor of the bus, and R1, R2, and R3 represents resistance components between the bus transmitter 210 and the bus receiver 220, between the bus receiver 220 and the bus receiver 230, and between the bus receiver 230 and the bus receiver 240, respectively. Therefore, as the bus receiver is farther from the bus transmitter 210, the larger resistance component is provided between the bus receiver and the bus transmitter.

In FIG. 2, C1, C2, and C3 represent stray capacitances of the bus receiver 220, the bus receiver 230, and the bus receiver 240, respectively.

In an N:N structure in which all the modules connected to the bus can arbitrarily use the bus, frames received by a predetermined node may include signal distortion of different degrees for each transmitter. In a master-slave structure limitatively using the bus, slave nodes communicate with only one master, but it is difficult to previously know the degree of the signal distortion at the time of designing the hardware module.

A circuit model between the bus transmitter and the bus receiver may be changed as time is changed. Conductive thread is frequently fabricated by twisting several threads of filaments in order to have a characteristic to elongate while being pulled like general thread. In this case, the conductivity of the entire thread equal to the sum of conductivities of the filaments.

FIG. 3 is a circuit diagram modeling a conductive thread constituted by several threads of filaments.

Referring to FIG. 3, the conductive thread between the bus transmitter and the bus receiver can be expressed by a circuit in which a plurality of resistors are connected to each other in parallel.

In FIG. 3, switches cut and recover the filaments. Total resistance components when the conductive thread is in a normal state in an initial stage are the same as a state in which resistors r are connected with each other in parallel and all the switches are turned on. The switches are turned off one by one to express a decrease in the conductivity of the conductive thread due to a physical factor given from the outside and the switches are turned on again to substitute superannuated conductive thread with new conductive thread.

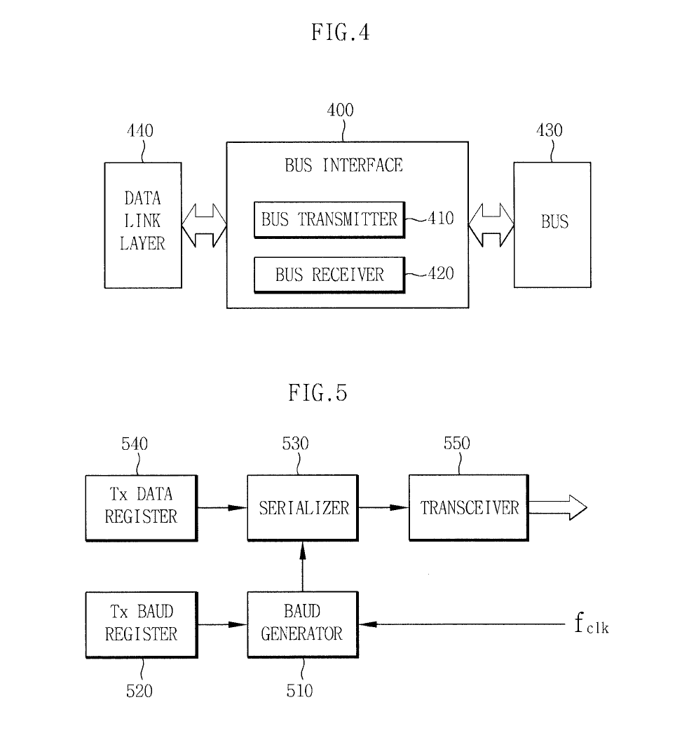

FIG. 4 is a block diagram showing a bus interface device according to an embodiment of the present invention.

Referring to FIG. 4, the bus interface device 400 includes a bus transmitter 410 and a bus receiver 420.

The bus interface device 400 may be implemented by a part of an integrated circuit (IC), implemented by one independent integrated circuit, or one or more integrated circuits. A data link layer 440 which is an upper layer may be implemented by software on a processor an additional integrated circuit, or a hardware block in a system on chip (SoC).

The bus transmitter 410 transmits data to a destination node at predetermined data rate by searching a transmission rate table whenever transmitting the data.

In this case, searching the transmission rate table and setting the data rate may be performed by the upper layer such as the data link layer. In this case, the bus transmitter 410 may transmit the data at data rate set by the upper layer.

The bus receiver 420 receives the data through a bus 430 and provides characteristics of a signal measured together with the received data to a node transmitting the received data so as to update the transmission rate table.

In this case, in the transmission rate table, available transmission rate is updated for each node transmitting the received data through the bus 430 and the data rate of the bus transmitter 410 may be set by retrieving the available transmission rate corresponding to the destination node to which the data will be transmitted from the transmission rate table.

In this case, the transmission rate table may be updated by the upper layer such as the data link layer.

The bus transmitter 410 and the bus receiver 420 may be connected with each other through the data link layer 440.

That is, when the bus receiver 420 receives the data from a node X, the bus receiver 420 transfers the characteristics of the signal measured together with the received data to the data link layer 440 and the data link layer 440 updates a transmission signal table by determining the available transmission rate for the node X by using the characteristics of the signal. The data link layer 440 provides the available transmission rate to the bus transmitter 410 when the bus transmitter 410 transmits the data to the node X to allow the bus transmitter 410 to transmit the data at the data rate set by using the available transmission rate. In this case, both the data rate and the available transmission rate may be a baud and the available transmission rate may be set as the data rate.

FIG. 5 is a block diagram showing an example of a bus transmitter shown in FIG. 4.

Referring to FIG. 5, the bus transmitter 410 shown in FIG. 4 includes a baud generator 510, a transmission baud register 520, a serializer 530, a transmission data register 540, and a transceiver 550.

The baud generator 510 receives a clock f_{clk} for its operation and the speed of the clock is equal to or larger than a baud of a generatable range. If the clock speed is smaller than the maximum generable baud, a clock module for generation of a faster clock may be additionally required.

An upper layer managing transmission and reception of data may select a baud to be used for transmission within a predetermined range by using the transmission baud register 520.

The baud generator 510 generates a baud corresponding to data rate to be used in transmission of serial data. The data for transmission is stored in the transmission data register 540 by the upper layer and when transmission is started, the serializer 530 transmits the transmission data to the transceiver 550 to fit the generated baud.

The transceiver 550 converts serial data of a logic level into a bus signal level.

Although not shown in FIG. 5, the bus transmitter may further include other function block such as a modulator or a demodulator.

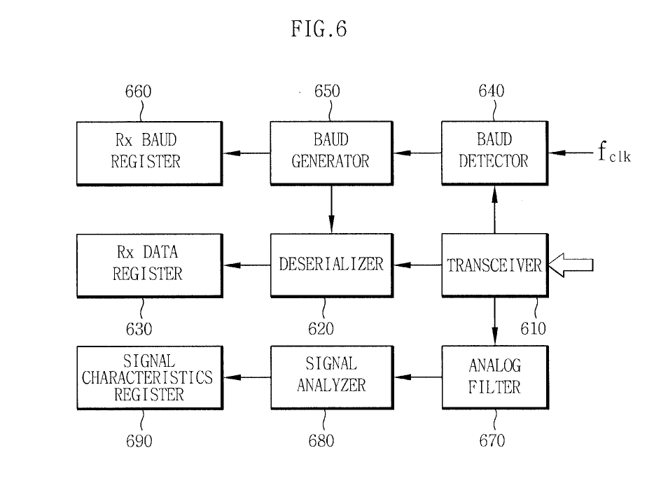

FIG. 6 is a block diagram showing an example of a bus receiver shown in FIG. 4.

Referring to FIG. 6, the bus receiver 420 shown in FIG. 4 includes a transceiver 610, a deserializer 620, a reception data register 630, a baud detector 640, a baud generator 650, a reception baud register 660, an analog filter 670, a signal analyzer 680, and a signal characteristics register 690.

The transceiver 610 converts a reception signal into a logic level. The reception signal converted into the logic level by the transceiver 610 is transmitted to the deserializer 620, the baud detector 640, and the analog filter 670.

The baud detector 640 analyzes a head of a received frame to extract a baud of the frame in real time. An extracted result is transmitted to the baud generator 650 in order to generate a baud clock of the frame. The baud generator 650 generates and provides the baud clock to the deserializer 620. The deserializer 620 generates the reception data by deserializing the baud clock and transmits the reception data to the upper layer through the reception data register 630. Baud information of the frame detected by the baud detector 640 is accessed by the upper layer through the reception baud register 660.

The bus receiver has a function to figure out characteristics of a bus signal in addition to a function to receive the frame.

The analog filter 670 performs signal processing of amplifying an input signal or converting a level of the input signal. The signal analyzer 680 extracts the characteristics from the signal received through the bus. In this case, the extractable signal characteristics may be a rise time, a fall time, a delay time such as a settling time, a voltage level indicating logics of 1 and 0, and/or overshoot. The extracted signal characteristics information is delivered to the upper layer through the signal characteristics register 690.

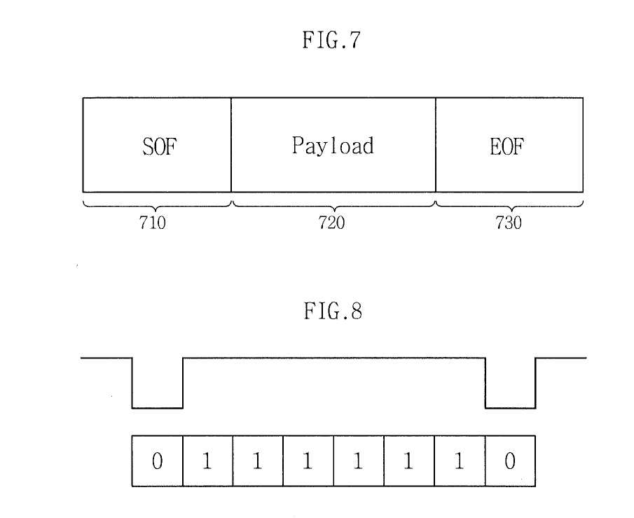

FIG. 7 is a diagram showing one example of a physical layer frame used in a bus interface of the present invention.

Referring to FIG. 7, the physical layer frame includes a start of frame (SOF) field 710 at a frame start location in addition to a payload field 720 and an end of frame (EOF) field 730. The SOF field 710 has a predetermined value in order to detect the baud of the frame in real time.

For example, the SOF filed 710 and the EOF field 730 may have a fixed length of 1 to 2 bytes and the payload field 720 may have a variable length.

As a method for determining of a value of the SOF field 710 and a method for detecting the baud by using the determined value, various methods may be used in accordance with an encoding type.

FIGS. 8 to 10 are diagrams showing one example of the SOF field shown in FIG. 7.

The examples shown in FIGS. 8 to 10 may be examples in the case of directly using a binary code without using an additional encoding type.

Referring to FIG. 8, the SOF field of the frame is set to a binary value of 01111110b, which is 1 byte long.

When the SOF field is set to 01111110b, a rise edge or a fall edge formed by 0 of the first bit and 0 of the last bit is detected to measure a time interval between the edges, thereby measuring the baud.

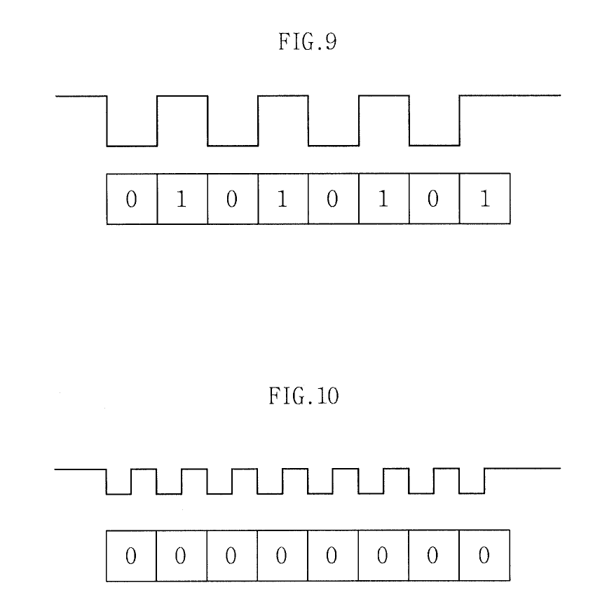

Referring to FIG. 9, the SOF field of the frame is set to a binary value 01010101b, which is 1 byte long. In this case, the baud may be detected by measuring the bit variation cycle.

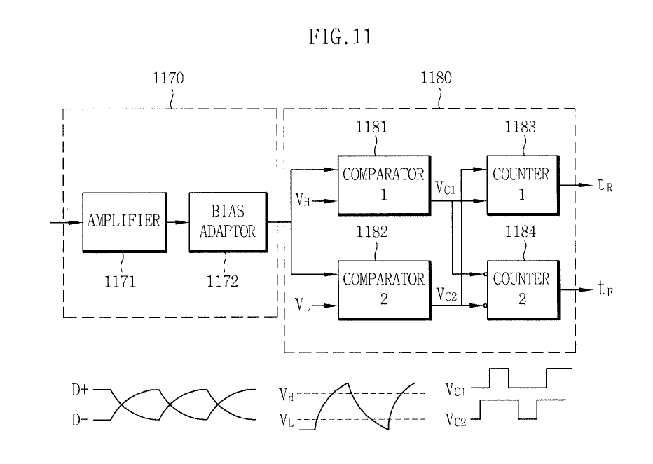

Referring to FIG. 10, a Manchester code in which voltage transition occurs within each bit is used.

In the case of using the Manchester code, when the SOF field is set a binary value of 00000000b which is 1 byte long, the baud may be detected by measuring a variation cycle of a logic level of the reception signal.

FIG. 11 is a diagram showing one example of an analog filter and a signal analyzer of a bus receiver shown in FIG. 6.

Referring to FIG. 11, the analog filter 1170 and the signal analyzer 1180 provide two delay values; a rise time t_{R} and a fall time t_{F} of a signal as the signal characteristics.

When the signal characteristic or characteristics to be detected are determined, even relating blocks in the upper layers such as the analog filter 1170, the signal analyzer 1180, the signal characteristics register, and the data link layer should be designed to have consistency.

In the example of FIG. 11, it is assumed that a differential signal is used in a bus and the differential signal is represented by D+ and D−.

The analog filter 1170 uses an amplifier 1171 and a bias adaptor 1172 to transform voltages of the input bus signals to meet effective input range of the signal analyzer 1180.

The signal analyzer 1180 includes comparators 1181 and 1182 and counters 1183 and 1184.

The comparator 1181 compares output voltage of the analog filter 1170 with the threshold voltage V_{H}. That is, the comparator 1181 outputs logic high only when the output of the analog filter 1170 is higher than the threshold voltage V_{H}.

The comparator 1182 compares output voltage of the analog filter 1170 with the threshold voltage V_{L}. That is, the comparator 1182 outputs logic high only when the output of the analog filter 1170 is higher than the threshold voltage V_{L}.

Amplification rate of the analog filter, a bias value, and the comparison input voltages V_{H} and V_{L} should be set to have a pertinent interrelationship.

When the output signal of the analog filter has signal delays, comparators 1181 and 1182 will generate pulses having different duties as outputs V_{C1} and V_{C2}.

The counter 1183 receives a rise edge of V_{C2} as a start trigger and a rise edge of V_{C1} as a termination trigger.

The counter 1184 receives a fall edge of V_{C1} as the start trigger and a fall edge of V_{C2} as the termination trigger.

Consequently, the delay time value measured by the signal analyzer 1180 is expressed by a binary counting value and the result thereof is delivered to the upper layer through the signal characteristics register.

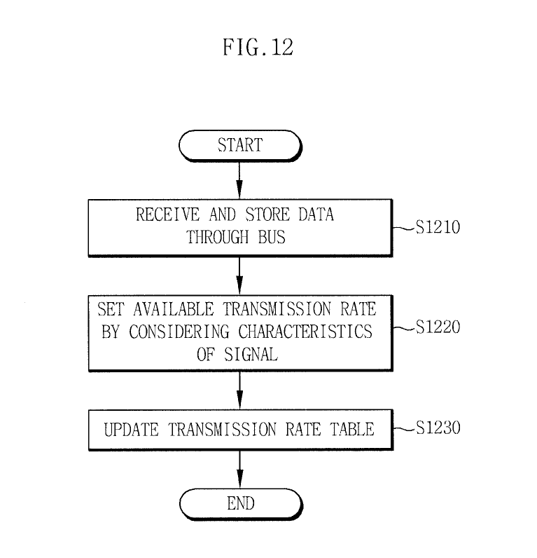

FIG. 12 is an operational flowchart showing a serial bus communication method according to an embodiment of the present invention.

Referring to FIG. 12, in the serial bus communication method, when data is received through a bus, the received data is stored in a buffer (S1210).

In this case, the data may be a data packet.

In this case, a signal indicating reception of the data may be delivered to an upper layer or an application program.

Further, in the serial bus communication method, available transmission rate related to a node transmitting the received data is set by considering characteristics of a signal measured together with the data received through the bus (S1220).

In this case, setting the available transmission rate may be performed by various methods.

For example, the characteristics of the signal may be a delay time of the signal such as a rise time or fall time of the signal and the available transmission rate may be set to become slower for longer delay time. In this case, the available transmission rate may be set to have a slight margin in addition to a value determined by the characteristics of the signal such as the delay time, etc.

As long as the measured characteristics of the signal satisfy an error rate condition between a current node and a node transmitting data, the available transmission rate is preferably set to the maximum value.

For example, communication is performed between the current node and the node transmitting the data by using a plurality of bauds to collect error rate data for each baud and the maximum allowable baud is experimentally acquired. Thereafter, a formula expressing the relationship between the delay time and the transmission rate (maximum baud) is acquired to set the available transmission rate in accordance with the acquired formula.

In this case, the node may be a hardware module connected through the bus.

Further, in the serial bus communication method, a transmission rate table is updated, such that the set available transmission rate becomes available transmission rate of the node (S1230).

In this case, the transmission rate table is searched whenever transmitting the data through the bus and may be used for data transmission.

According to the embodiment, in the serial bus communication method shown in FIG. 12, data rate is set by using the transmission rate table and an ACK signal may be transmitted at the set data rate.

In the example shown in FIG. 12, the unit of data rate may be a baud, but according to the embodiment, the data rate may use various other units capable of indicating the data rate.

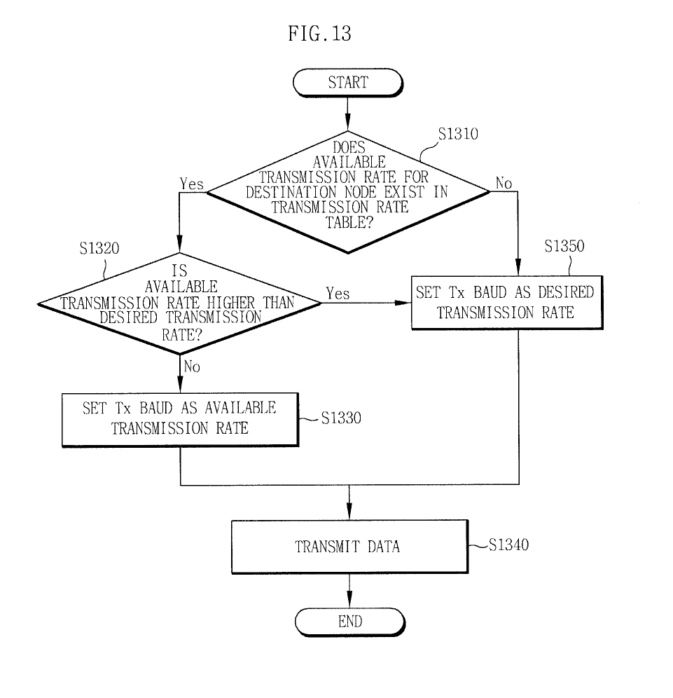

FIG. 13 is an operational flowchart showing a serial bus communication method in data transmission according to an embodiment of the present invention.

Referring to FIG. 13, in the serial bus communication method, available transmission rate for a destination node to which the data will be transmitted is retrieved from the transmission rate table whenever transmitting the data through the bus and it is judged whether or not the available transmission rate for the destination node exists in the transmission rate table (S1310).

In a general serial bus system, transmission rate for transmission and reception is set at a system design step or during bus initialization, while in the serial bus communication methods shown in FIG. 13, the transmission rate is set whenever transmitting data such as a packet or a frame.

In this case, the transmission rate table is updated by considering the measured characteristics of the received signal together with the received data for each node transmitting the received data through the bus. In this case, the characteristics of the signal may be a delay time and the transmission rate table may be updated, such that as the delay time is longer, the available transmission rate corresponding to the delay time becomes slower. In this case, the available transmission rate corresponding to the characteristics of the signal is preferably updated to have the maximum value within a range for the signal characteristics to satisfy the error rate condition.

For example, when the current node is connected with node A, node B, and node C through the bus and the current node has ever received data from node A, node B, and node C, available transmission rate for node A, available transmission rate for node B, and available transmission rate for node C are stored in the transmission rate table.

In this case, available transmission rate for a node that has not ever received data up to now may not be recorded in the transmission rate table.

When the available transmission rate is provided and retrieved at step S1310, the retrieved available transmission rate and desired transmission rate set by the application program in an initial stage are compared with each other to judge whether or not the retrieved available transmission rate is higher than the desired transmission rate (S1320).

If the available transmission rate is not higher than the desired transmission rate, the available transmission rate is set as data rate at which data is transmitted to a target node (S1330).

In this case, the unit of the available transmission rate and the data rate may be a baud.

If the available transmission rate is higher than the desired transmission rate, the desired transmission rate is set as the data rate at which the data is transmitted to the target node (S1350).

In this case, the unit of the desired transmission rate and the data rate may be the baud.

When the available transmission rate is not provided and thus not retrieved at step S1310, the desired transmission rate is used to set the data rate to the destination node. That is, at the application program initialization step, predetermined desired transmission rate is set as the data rate (S1350).

When the data rate is set, data transmission to the target node is started at the set data rate (S1340).

According to the embodiment, the serial bus communication method shown in FIG. 13 may further include judging whether or not the ACK signal for the transmitted data is successively received and judging whether the data transmission is succeed or failed in accordance with the judgment result.

All or some of operations shown in FIGS. 12 and 13 may be performed by the data link layer.

When one hardware module (node) is connected to the bus for the first time, information on available transmission rate (i.e., the maximum baud) usable in communication with other modules is not enough. Therefore, when the desired transmission rate (i.e., desired baud) is set too high compared to the capacity of the communication line, a lot of packet losses may be generated.

According to the serial bus communication method of the present invention, a lot of information on many nodes is gradually acquired with transmission and reception of the data and as a result, transmission rate that meets the given error rate criterion will be found.

In particular, since the delay time information and the available transmission rate are frequently updated between two modules that frequently transmit and receive packets, it is possible to set a pertinent transmission rate by reflecting a change of characteristics of the bus as soon as conductivity of the bus line between the modules is changed due to abrasion, etc.

As described above, the preferred embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A serial bus communication method, comprising:
retrieving available transmission rate to a destination node to which data will be transmitted from a transmission rate table whenever transmitting data through a bus;
setting data rate for transmitting the data to the destination node by using the retrieved available transmission rate when the available transmission rate to the destination node is retrieved from the transmission rate table; and
transmitting the data at the data rate.

2. The serial bus communication method according to claim 1, wherein the transmission rate table is updated based on characteristics of the signal measured together with the received data for each of nodes transmitting the received data through the bus.

3. The serial bus communication method according to claim 2, further comprising setting the data rate by using predetermined desired transmission rate at an initial stage when the available transmission rate for the destination node is not retrieved from the transmission rate table.

4. The serial bus communication method according to claim 2, wherein the setting the data rate sets the data rate to the desired transmission rate when the available transmission rate is higher than the predetermined desired transmission rate at an initialization stage.

5. The serial bus communication method according to claim 2, wherein the data rate is a baud.

6. The serial bus communication method according to claim 2, wherein the characteristics of the signal are a delay time of a signal and the transmission rate table is updated, such that the corresponding available transmission rate becomes lower as the time delay is longer.

7. The serial bus communication method according to claim 2, wherein the transmission rate table is updated, such that the available transmission rate corresponding to the characteristics of the signal has the maximum value at which the signal characteristics satisfy an error rate condition.

8. A serial bus communication method, comprising:
setting available transmission rate relating to a node transmitting received data by considering characteristics of a signal measured together with the data received through a bus; and
updating a transmission rate table such that the set available transmission rate is available transmission rate for the node.

9. The serial bus communication method according to claim 8, wherein the transmission rate table is searched whenever data is transmitted through the bus and the transmission rate table is used to set data rate used for the data transmission.

10. The serial bus communication method according to claim 9, wherein the data rate is a baud.

11. The serial bus communication method according to claim 9, wherein the characteristics of the signal are is a delay time of the signal and the available transmission rate is set to become slower as the delay time is longer.

12. The serial bus communication method according to claim 9, wherein the setting available transmission rate sets the available transmission rate to the maximum value at which the characteristics of the signal satisfy an error rate condition for the node.

13. A bus interface device, comprising:
a bus transmitter transmitting data to a destination node at a data rate set by searching a transmission rate table whenever transmitting the data; and
a bus receiver receiving data through a bus and providing characteristics of a signal measured together with the received data to update the transmission rate table for a node transmitting the received data.

14. The bus interface device according to claim 13, wherein available transmission rate is updated for each node transmitting the data received through the bus in the transmission rate table, and
the data rate is set by using the available transmission rate corresponding to the destination node.

15. The bus interface device according to claim 14, wherein the bus transmitter includes:
a baud generator generating a baud corresponding to the data rate;
a serializer serializing the data with the baud; and
a transceiver converting a signal outputted by the serializer into a bus signal level.

16. The bus interface device according to claim 14, wherein the bus receiver includes:
a transceiver converting a signal received from the bus into a logic level;
a baud detector extracting a baud of a frame by analyzing a header of the frame outputted by the transceiver;
a baud generator generating a baud clock by using the extracted baud;
a deserializer deserializing the signal outputted by the transceiver by using the baud clock; and
a signal analyzer providing characteristics of the signal from the signal outputted through the transceiver.

17. The bus interface device according to claim 16, wherein the signal analyzer outputs a binary delay time value.

18. The bus interface device according to claim 17, wherein the signal analyzer includes:
comparators comparing an input signal with comparison input voltage; and
counters counting output signals of the comparators with start and termination triggers, respectively.
